(19) United States
(12) Patent Application Publication
(10) Pub. No.: US 2019/0084142 A1
(43) Pub. Date: Mar. 21, 2019

(54) HAND TOOL WITH INTERCHANGEABLE HEAD

(71) Applicant: Tom Vu, Fresno, CA (US)

(72) Inventor: Tom Vu, Fresno, CA (US)

(21) Appl. No.: 15/709,973

(22) Filed: Sep. 20, 2017

(51) Int. Cl. B25F 1/02

(52) U.S. Cl. CPC B25F 1/02

(57) ABSTRACT

A hand tool with interchangeable tool bits that includes: a hand grip; a neck extending from the hand grip; a tool insert with in the neck; and a plurality of tool bits available for insertion into the tool insert. The plurality of tool bits includes at least one wrench and a screwdriver, where the at least one wrench includes a box wrench, an open wrench and a socket wrench. The screwdriver may include a flat tip and a Phillips tip.

### BACKGROUND OF THE INVENTION

### Field of Invention

The present invention relates to a hand tool that has a cylindrical hand grip, which in adapted to receive various tools for use therewith.

### Description of Related Art

Hand tools are common tools used in various types of applications. Manual hand tools include screw drivers, wrenches, hammers, clamps and wire pliers to name a few. These different tools are used in various applications in general construction and handy man jobs. Typically, a user might need to use various tools on one particular project such as different type of wrenches, screw drivers, Phillips type screw drivers, socket wrenches and so forth. As a result, it would be advantageous to have a single tool that could interchangeable head and allow many uses that use a single gripping device for multiple tools. The present invention.

### SUMMARY OF THE INVENTION

The present invention relates to a hand tool with interchangeable tool bits that includes: a hand grip; a neck extending from the hand grip; a tool insert with in the neck; and a plurality of tool bits available for insertion into the tool insert. The plurality of tool bits includes at least one wrench and a screwdriver, where the at least one wrench includes a box wrench, an open wrench and a socket wrench. The screwdriver may include a flat tip and a Phillips tip.

### BRIEF DESCRIPTION OF DRAWINGS

FIG. 1 shows a system for the hand tool in accordance with the present invention.

### DETAILED DESCRIPTION

The present invention includes is a hand tool that has a single cylindrical hand gripping device that includes a tool insert. The tool insert allows for the insertion of various types of tools but such as a wrench in three different varieties and two-headed screw bits. The present invention provides a hand grip that allows for the insertion of either a box wrench, an open wrench or a socket wrench. Further a screw driver may be inserted into the tool insert as needed. This particular tool therefore provides a single hand grip that is available to the various inserts.

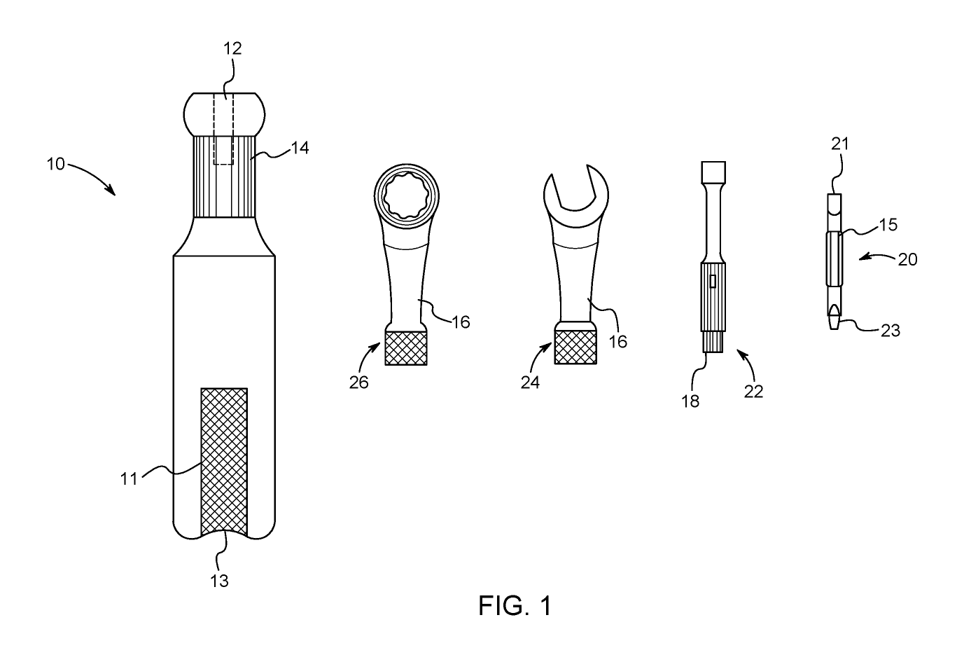

In reference to FIG. 1, a hand grip 10 is depicted. The hand grip 10 includes a cylindrical gripping surface and a neck area 14. At the top of the neck area 14 is an opening for a tool insert 12. The tool insert 12 allows for the insertion of tools shown in FIG. 1. FIG. 1 depicts three different types of wrenches, a box wrench 26, an open end wrench 24 and a socket wrench 22. Both the box wrench 26 and the open end wrench 24 include an attachment bit 16. The attachment bit 16 inserts into the tool insert opening 12. The socket wrench 22 also includes a bit 18 that goes into the tool insert 12. These wrenches are interchangeable with the hand grip 10 and provide some versatility in the types of wrenches that can be used in conjunction with the hand grip 10. Alternatively, the hand grip 10 may be converted into a screw driver using a screw driver bit 20. The screw driver bit 20 includes a flat screwdriver 21 and a Phillips screwdriver 23. This screw driver bit 20 allows the user to convert either side into an open position and allow the insertion of the bit 15 into the tool insert 12. The screw driver bit 20 goes into a receiver 11 where the receiver 11 includes a curved edge 13. Onced engaged with this receiver 11, a user may then utilize either end of the screw driver bit 20. This interchangeability provides a unique hand tool kit for use by a user.

The foregoing descriptions of specific embodiments of the present invention have been presented for purposes of illustration and description. They are not intended to be exhaustive or to limit the invention to the precise forms disclosed, and obviously many modifications and variations are possible in light of the above teaching. The exemplary embodiment was chosen and described in order to best explain the principles of the invention and its practical application, to thereby enable others skilled in the art to best utilize the invention and various embodiments with various modifications as are suited to the particular use contemplated.

What is claimed is:

1. A hand tool with interchangeable tool bits comprising:
a. a hand grip;
b. a neck extending from the hand grip;
c. a tool insert with in the neck; and
d. a plurality of tool bits available for insertion into the tool insert.

2. The hand tool according to claim 1, where the plurality of tool bits includes at least one wrench and a screwdriver.

3. The hand tool according to claim 2, where the at least one wrench includes a box wrench, an open wrench and a socket wrench.

4. The hand tool according to claim 2, where the screwdriver includes a flat tip and a Phillips tip.
